(19) United States
(12) Patent Application Publication
(10) Pub. No.: US 2013/0151454 A1
(43) Pub. Date: Jun. 13, 2013

(54) Weather comfort forecasting for riders of motorcycles and other exposed-rider vehicles

(71) Applicant: Wil McCarthy, Lakewood, CO (US)

(72) Inventor: Wil McCarthy, Lakewood, CO (US)

(21) Appl. No.: 13/710,213

(22) Filed: Dec. 10, 2012

Related U.S. Application Data
(60) Provisional application No. 61/568,941, filed on Dec. 9, 2011.

(51) Int. Cl. G06N 5/02; G06F 17/50

(52) U.S. Cl. CPC G06N 5/02; G06F 17/5009
USPC 706/46; 703/2

(57) ABSTRACT

A method for predicting and reporting rider comfort on exposed-rider vehicles uses weather report data and riding speeds to calculate an effective temperature. Personal preferences may also be set and considered to provide predictive information and recommendations particular to sensibilities of individual riders. This method may be used as an aid to planning ride times, durations, and wardrobe choices as a function of time of day and planned riding speeds.

### CROSS REFERENCE TO RELATED APPLICATIONS

This application claims the benefit of priority pursuant to 35 U.S.C. §119(e) of U.S. provisional application No. 61/568,941 filed 9 Dec. 2011 entitled “Weather comfort forecasting for riders of motorcycles and other exposed-rider vehicles,” which is hereby incorporated herein by reference in its entirety

### BACKGROUND

1. Technical Field

The subject matter described herein relates to a method for predicting and reporting rider comfort on motorcycles and other exposed-rider vehicles, based on a local weather forecast, rider preferences, and expected riding speed.

2. Description of the Related Art

The concept of Wind Chill Factor is well known, and widely used in reporting winter weather conditions. Similarly, the concept of Heat Index—a modification of perceived temperature based on sunlight and humidity—is also well known, and while less familiar than Wind Chill Factor, is frequently used in reporting summer weather conditions. The more complex Apparent Temperature scale takes sunlight, humidity, and wind chill into account, and is thus more flexible, at least in theory, than either Wind Chill or Heat Index alone.

However, the concept of Wind Chill Factor was developed by Antarctic explorers, specifically to evaluate the risk of frostbite. Above temperatures of approximately 60 F, the Wind Chill Factor equation gives answers that diverge significantly from subjective human experience. Similarly, Heat Index is not intended to apply to ambient conditions below room temperature, and the Apparent Temperature scale (developed in the hot, humid conditions of Quantico, Va.) was originally developed to prevent overheating of military troops during warm weather training exercises. In addition, all three scales presume an active human being moving under his/her own power, at very low speed and in conditions of relatively mild wind speed.

A number of scales also exist for estimating the thermal comfort of people inside buildings. These include the ASHRAE-55 standard, the Kansas State University apparent temperature scale, the Fanger and Pierce “Predicted Mean Vote” algorithms, and the Pierce TSENS (or sensed temperature) index. These measurements take various account of temperature, humidity, air velocity, and sunlight, within the fairly sharp constraints of the conditions that can reasonably be expected indoors.

None of these constraints or assumptions are generally valid for motorcycles, or other vehicles or modes of transport wherein the rider is outdoors, uncovered, and exposed directly to the airstream, and the sustained speed of travel is equal to or higher than the speed of typical ambient wind gusts. For example, the wind chill charts published by the National Weather Service generally only cover wind speeds of 60 mph or lower, and temperatures of 40 F and below. The rider of a motorcycle traveling at 75 mph, through a mild 10 mph headwind, at 75 F ambient temperature on a clear, sunny day, is exposed to conditions not presumed by the Wind Chill Factor calculations, or indeed any of the above scales. The subjective rider experience—that he or she feels cooler at higher speeds—is not well predicted by any of the algorithms already described. Indeed, the prior art does not include an effective temperature scale that is intended for, or valid for, the conditions of exposed-rider travel.

In addition, while tables and equations in the public domain make it fairly straightforward to calculate Wind Chill Factor, Heat Index, and Apparent Temperature for a given set of ambient conditions, the rider of a motorcycle, snowmobile, hang glider, boat, or other exposed-rider conveyance will find that such tools do a very poor job of predicting rider comfort, even when the ambient conditions are well described. A software tool called “Motorcycle Weather”, developed by Kickstand Technology, LLC as an application for smart phones running the Android operating system, attempts to resolve this deficiency by providing a visual “Ride”/“Do Not Ride” indicator based on a cross-reference between the day's weather prediction and rider preferences of temperature, wind speed, and chance of precipitation. However, this tool offers what amounts to a single worst-case prediction, making no allowances for intended travel speed, or for the often-substantial variation of weather conditions across the course of the day. Furthermore, the “Motorcycle Weather” tool does not offer any indication as to why motorcycling is recommended or not recommended for the given day. Thus, the rider is not afforded any opportunity to modify behavior in order to mitigate upcoming comfort issues.

Such information—predicted comfort as a function of travel speed and time of day—would be extremely useful to riders in determining what protective clothing to wear and/or pack for different times of day. Unfortunately, the prior art does not include an effective software tool or method for advising motorcyclists, and other exposed riders, of the apparent or effective temperatures they will experience over the course of a day, as a function of travel speed, based on (for example) hourly weather predictions from the National Weather Service for the locality or localities of intended travel.

The information included in this Background section of the specification, including any references cited herein and any description or discussion thereof, is included for technical reference purposes only and is not to be regarded as subject matter by which the scope of the invention as defined in the claims is to be bound.

### SUMMARY

The technology disclosed herein consists of three main components for implementation on a microprocessor-controlled device: first, a set of methods or algorithms for determining effective or apparent temperature as a function of travel speed; second, a switching algorithm or method (e.g., a fuzzy logic controller) for selecting the most appropriate apparent temperature prediction, or a blending of two or more predictions; and third, a method for reporting the apparent temperature as a function of time of day and travel speed.

The methods disclosed herein have particular, but not exclusive, application for motorcyclists, snowmobilers, sailors, ultralight pilots, and the drivers and passengers other exposed-rider vehicles, as an aid to planning the times and speeds of riding over the course of a coming day. The methods disclosed herein allow the drivers and passengers of exposed-rider vehicles to predict their comfort at various riding speeds as a function of the time of day. This prediction simplifies the planning of rides maximum comfort and safety. The prediction may also suggest minimum and maximum comfortable riding speeds at specified riding times and serve as an aid in trip planning. The predictive out put may provide a guideline for selecting appropriate protective clothing for a ride, based on the times, location, riding speeds, and predicted weather. The predictive logic may further provide a “GO”/“NO-GO” indication as to whether a particular trip at a particular time is advisable at all.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments and implementations and illustrated in the accompanying drawings.

### BRIEF DESCRIPTION OF THE DRAWINGS

FIG. 1 is an exemplary representation of a User Preferences setup screen.

FIG. 2 is an exemplary representation of a simple hourly GO/NO-GO output screen.

FIG. 3 is an exemplary representation of an hourly Worst Case Effective Temperature (WCET) output screen.

FIG. 4 is an exemplary representation of an output screen showing hourly GO/NO-GO advisories based on specific user preferences.

FIG. 5 is an exemplary output screen combining simple hourly GO/NO-GO reporting, preference-based GO/NO-GO reporting, and a WCET table.

FIG. 6 is an exemplary output screen in which Effective Temperature and GO/NO-GO warning data is overlaid on a Google Maps trip planning screen.

FIG. 7 is a flow diagram of an exemplary computer software process for calculating an effective temperature and providing a GO/NO-GO recommendation.

FIG. 8 is schematic diagram of a computer system that may be used to implement the software process of FIG. 7.

### DETAILED DESCRIPTION

In the technology disclosed herein, apparent or effective temperature is calculated by any or all of several different methods. For example, the standard NWS Wind Chill Factor equation:

Tₑ=35.74+0.6215*Tₐ−35.75*Ŝ0.16+0.4275*Tₐ*Ŝ0.16 Equation 1

(where Tₑ and Tₐ are the effective and ambient temperatures in degrees Fahrenheit, and S is the wind speed in miles per hour)
offers a reasonable prediction of apparent or effective temperature for ambient temperatures of 65 F and below. However, in practice the ambient wind speed is always nonzero, and thus the actual wind speed experienced by a rider of an exposed-rider vehicle is the vector sum of vehicle velocity and ambient wind velocity. Since this vector sum changes instantaneously from moment to moment, it cannot be predicted in advance. However, the two extreme cases—a direct headwind and direct tailwind—can be calculated simply by respectively adding and subtracting the ambient wind speed and vehicle speed. Thus, two different Effective Temperatures are calculated, one of which will later be determined to be the Worst Case Effective Temperature, or WCET.

At ambient temperatures between 70 F and 90 F, a modified version of the Wind Chill Factor equation may be used. It should be understood that the range of equations or methods capable of calculating useful values is bounded but infinite, and the scope of the implementations disclosed herein shall not be bound by the details of any particular equation, method, or table lookup. Nevertheless, the following equation (provided herein for exemplary purposes) has been found to match empirical rider experience:

Tₑ=39.0+0.6215*Tₐ−42*Ŝ0.16+0.4275*Tₐ*Ŝ0.16 Equation 2

However, the above equation does not yield accurate results for ambient temperatures above 90 F. Generally speaking, when the ambient temperature approaches or exceeds body temperature, the subjective experience of a rider is that the wind becomes “hot” rather than “cool”, and that faster travel makes the wind (and thus the rider) feel hotter rather than cooler. Once again, a vast number of different equations or methods may be used to describe this subjective effect, but the following equation is provided herein for exemplary purposes:

Tₑ=30.0+0.6215*Tₐ−35.75*Ŝ0.16+0.4275*Tₐ*Ŝ0.16 Equation 3

It may be noted that the values produced by these equations do not line up perfectly at any temperature. This is even more true of the slopes of the values with respect to both speed and temperature. Therefore, to prevent discontinuities when switching between equations at a given threshold temperature, it is helpful to define an “in between” region where the values from two or more equations are averaged or otherwise blended together. This principle will be familiar to designers and users of so-called “fuzzy logic” controllers. Again, the exemplary implementations described herein should not be bound by the details of any particular switching method. Nevertheless, the following switching method is provided herein for exemplary purposes:

At ambient temperatures equal to or below 65 F, use equation 1.

At ambient temperatures above 65 F and below or equal to 70 F, use the average of equation 1 and equation 2.

At temperatures above 70 F and below or equal to 90 F, use the average of equation 2 and equation 3.

At temperatures above 90 F, use equation 3.

The next step is to account for the effects of sunlight and humidity. It is observed that very complex calculations, such as the Apparent Temperature and PMV algorithms described above, do not necessarily yield accurate results. Furthermore, the subjective experiences of sunlight and humidity can be described very simply. Sunlight makes a given ambient temperature feel warmer, regardless of other circumstances, and the absence of sunlight makes the same temperature feel cooler. This effect can be approximated quite simply, by treating full sunshine as the “normal” or baseline condition for riding, and computing an “effective” temperature by subtracting 5 degrees Fahrenheit from the ambient or wind chill temperature during hazy or partly cloudy conditions, and subtracting 10 degrees during overcast or nighttime conditions. This calculation is provided herein for exemplary purposes, as a wide variety of other simple additions, subtractions, or multipliers may be used to achieve a similar effect, whether employing sunshine or some other lighting condition as the baseline.

Humidity may be handled in a manner only slightly more complex. High humidity makes warm temperatures feel warmer and cool temperatures feel cooler. Thus, in an exemplary embodiment, when the ambient temperature is 66 degrees Fahrenheit or lower, the effective temperature in degrees may be modified by subtracting one-fifth of the relative humidity in percent. When the ambient temperature is 74 degrees or higher, the effective temperature may be modified by adding one-fifth of the relative humidity. For temperatures in between 66 degrees an 74 degrees, the effective temperature may be added to relative humidity times 1% of the difference between ambient temperature and 70 F. However, a variety of other approximations may be used instead and this methodology is only exemplary.

At this point, this exemplary method has yielded two different numbers based on ambient temperature, sunshine level, relative humidity, ambient wind speed, and vehicle speed. These two numbers represent the rider's perceived Effective Temperature (ET) in degrees Fahrenheit, for the extreme cases of full tailwind and full headwind. In the next step of the method, the Worst Case Effective Temperature (WCET) is selected as the member of this pair that is farthest from the “ideal” perceived temperature of 70 F.

Based on a weather forecast (e.g., the 24-hour, hourly forecast available from the National Weather Service for a particular zip code or GPS location), this WCET number can be calculated for a variety of times and speeds throughout the day, and reported to the rider as an aid to planning the times, routes, speeds, and protective wardrobe of riding opportunities throughout the day ahead or, with less accuracy and less granularity, throughout the 10-day period ahead.

The final step in the method is to report this information to the rider in a compact, easily understood format that can be viewed and perceived quickly and without a great deal of technical or meteorological expertise. In one exemplary embodiment, the WCET is presented in tabular form, with one axis of the table representing different times of day, and the other axis representing different riding speeds. The rider can then look at this table, find the time and speed of a desired ride, and see the corresponding WCET value. The visual communication of this information may be further enhanced by color coding. In one exemplary embodiment, WCET values below a specified rider minimum may be displayed in a first color (e.g., purple), as a warning that these conditions are too cold for riding, and WCET values above a specified rider maximum may be displayed in a second color (e.g., red), as a warning that these conditions are too hot for riding. WCET values in between these two extremes may be colored in a third color (e.g., blue) for “cool” temperatures (e.g., those below 65 F), in a fourth color (e.g., green) for “comfortable” temperatures (e.g., those between 65 and 75 F), in a fifth color (e.g., yellow) for “warm” temperatures (e.g., those between 75 and 85 F), and in a sixth color (e.g., orange) for “hot” temperatures (e.g., those above 85 F). In this case, the actual WCET numbers may not be strictly necessary for the rider's understanding of predicted comfort levels, and may optionally be deleted. The implementations contemplated herein encompass embodiments with and without numbers, and with and without color coding.

Another alternative is to report the WCET results simply as “GO” or “NO GO” conditions (e.g., “green light” or “red light”, “OK” or “NO”, etc.), based on whether the WCET is within the rider's specified maximum and minimum acceptable WCET. Other variants on the method may take additional user preferences into account, such as darkness (e.g., if the specified riding time occurs after NWS reported sunset time), frost (if the ambient temperature is below freezing), rain (if the chance of precipitation exceeds a threshold value), snow (a combination of rain and frost conditions), or maximum desired wind speed, to issue a “GO” or “NO GO” recommendation based on expected conditions at any given future time.

These calculations can be made for any desired location for which a weather forecast is available. For example, a rider may choose to calculate expected conditions at the start, middle, and end point of a planned ride. This functionality may also be merged with trip planning software, e.g., Google Maps, such that a route and travel time may be calculated automatically, and WCET and/or GO/NO-GO information are pulled up at any point along the route based on the expected travel speed and time of arrival at that point. In addition, since the direction of travel is known in this case, it is possible to calculate a particular ET based on the vector sum of the predicted wind velocity and predicted vehicle velocity, rather than a Worst Case ET based on a headwind or tailwind.

It should be understood that numerous variations on these calculations may be employed to predict “perceived temperature” on motorcycles and other exposed-rider vehicles. For example, metric units may be used in place of English units, or the exemplary equations disclosed herein may be modified to produce comparable results by a different calculation, or the calculations may be performed in a different order than specified herein. One or more calculations could be dropped from the method in order to make it faster or easier to calculate, though with less accurate results. Color-coding of values could be different than specified herein, and Effective Temperature values could be reported graphically, audibly, as a pop-up or callout, or through vibration or temperature or other sensory feedback.

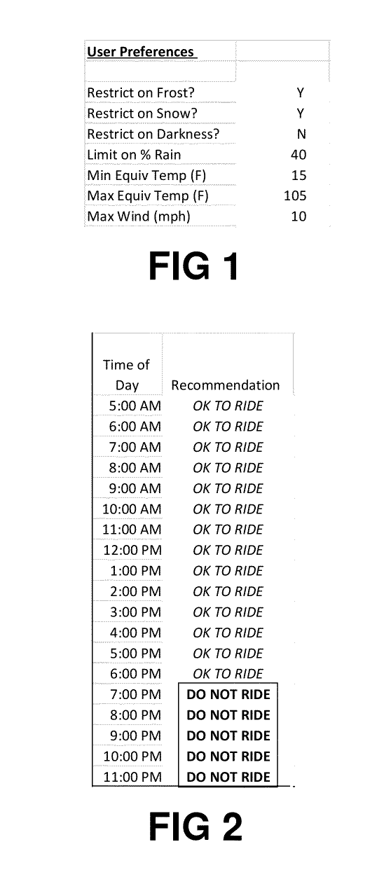

FIG. 1 is a representation of a setup screen wherein user preferences related to personal comfort with respect to various potential weather, time of day, and other possible travel conditions are specified. In an exemplary embodiment, the preferences available to the user may be frost, snow, darkness, rain, minimum and maximum “effective temperature”, and maximum ambient wind speed. For example, if the user specifies a “frost” restriction, then the software will issue a warning for times when the ambient temperature is equal to or less than 32° F. If the user specifies a snow restriction, then the software will issue a warning for times when a particular set of conditions occur that make snow a possibility. Because snow is a particularly hazardous condition for motorcycles, it may be desirable to set these parameters very conservatively within the software, e.g., if the ambient temperature is below 40 F and the chance of precipitation is 10% or greater. If the user specifies a “darkness” restriction, then the software may issue a warning for specific times, e.g., more than 30 minutes before the predicted sunrise or 30 minutes after the predicted sunset.

In one exemplary embodiment, the remaining user preferences are all numerical rather than Yes/No. For example, the “rain” preference may be specified as a maximum allowable chance of precipitation; if the predicted chance of precipitation equals or exceeds this value (e.g., 40%) at any given time, then the software will issue a warning for that time, as an aid to planning appropriate ride times. The maximum and minimum “effective temperature” restrictions are entered in degrees Fahrenheit, such that the software can issue a warning for times and speeds when the predicted ambient conditions will cause the effective temperature to fall outside this range. In one implementation, the effective temperature limits may be described as: “What are the minimum and maximum temperatures at which you would be comfortable, sitting in the sunlight for long periods while sheltered from the wind?” Maximum ambient wind speed may be specified in miles per hour (e.g., 30 mph) or kilometers per hour, such that for times when the predicted ambient wind speed exceeds this value, the software may issue a warning for those times, as an aid to planning.

These descriptions are provided for exemplary purposes only, and should not be considered to limit the scope of the present disclosure. User preferences may be added or removed and, indeed, the technology may function perfectly well using default or average values with no user input whatsoever.

FIG. 2 is an exemplary output screen showing hourly “GO”/“NO-GO” recommendations in a simple format based, for example, on user-specified preferences for restriction on snow, frost, temperature, ambient wind speed, etc. This output format may be preferred by some users, as it limits the amount of information that needs to be viewed in order to plan appropriate riding times. Therefore, the software may optionally allow the user to view output data in this format, or a related format. However, this output screen is provided herein for exemplary purposes only and the particular formatting of output data may vary tremendously. For example, the GO/NO-GO data could be presented as color codes (e.g., “green light”/“red light”), words, numbers, different fonts or font characteristics, pictograms, (e.g., Chinese characters), icons (e.g., motorcycle vs. car), audible warnings, or any combination thereof.

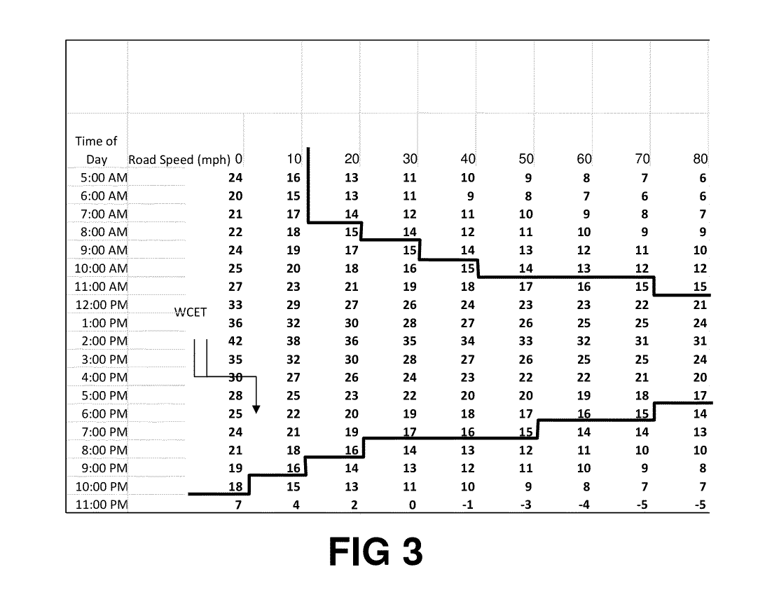

FIG. 3 depicts an exemplary output screen wherein the effective temperature (whether WCET based on the worst-case of either headwind or tailwind, or ET based on the vector sum of vehicle velocity and ambient wind velocity) is displayed in tabular form, with one axis representing the time of day and the other axis representing the range of possible vehicle speeds. In this example, the effective temperature data may be portrayed both numerically (with a discrete value shown for every combination of time and vehicle speed) and in terms of a color code (with a comfort-related color shown for every combination of time and vehicle speed). (For example, a color (e.g., blue) filling in between the black lines may be used to indicate cool riding temperatures and a color (e.g., purple) above the upper black line and below the lower black line may be used to indicate that the riding temperatures are extremely cold and, therefore, not advisable.) However, it may be understood that color codes displayed without numerical data, or numerical data displayed without color codes, would provide essentially the same information to the user and are therefore both embodiments contemplated herein. Furthermore, it may be understood that display parameters such as colors and color ranges, fonts and significant digits, table axes, and orientation could vary considerably in embodiments contemplated herein. In fact, the user may employ this system to plan rides perfectly well without any reference to such detailed tabular data, and thus some contemplated embodiments may not display such data at all.

However, it should be noted with that this tabular data may provide the greatest detail and flexibility for planning of safe and comfortable rides. For example, on a given day a rider might determine that conditions prior to 8 AM will not be comfortable at any speed, but that conditions at 9 AM will be comfortable as long as cold weather gear is worn and the vehicle speed is kept below 50 miles per hour, and (with cold weather gear) conditions at 10 AM will be comfortable at any speed below 80 miles per hour. This allows for greater application of the user's daily judgment and mood, and more particular advice on wardrobe selection, than a simple GO/NO-GO recommendation based on generic preferences.

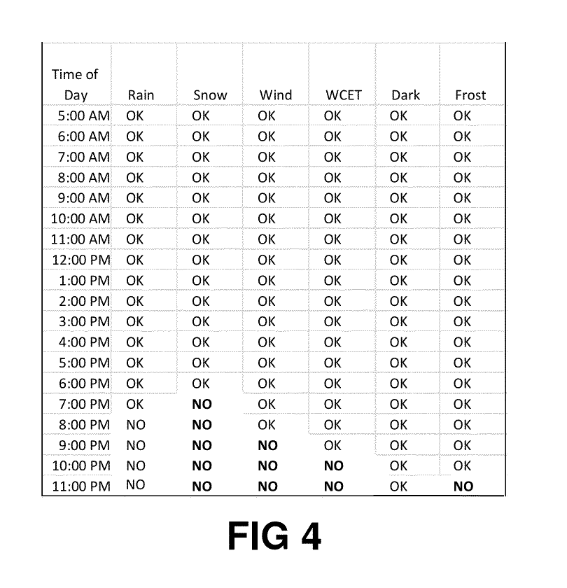

FIG. 4 depicts an exemplary GO/NO-GO table in hourly format, similar to the depiction in FIG. 2, but with the GO/NO-GO criteria clearly specified in terms of user preferences. With output in this format, the user can see the exact reason or reasons for a NO-GO type warning at any given time of day. Again, this allows the user to apply greater personal judgment in the planning of rides and ride times. For example, a user might study the exemplary recommendations in FIG. 4 and conclude that he or she must get home prior to 7:00 PM in order to avoid the risk of snow. Alternatively, a user studying the same data might conclude that he or she should not ride at all that day (e.g., should drive a car to work instead), because the possibility of being on the roads past 7:00 PM presents an unacceptable risk. These scenarios are provided for exemplary purposes only.

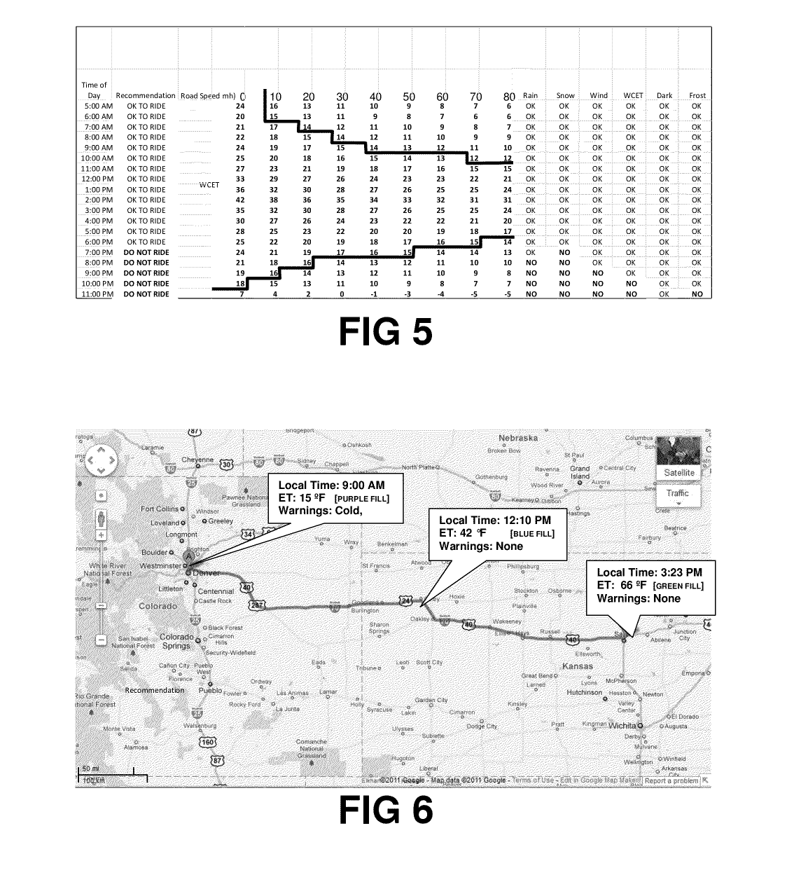

FIG. 5 depicts an exemplary “full featured” output screen in which simple GO/NO-GO recommendations, detailed GO/NO-GO recommendations, and tabular effective temperature data are presented simultaneously. This arrangement may supply the user with a large amount of detailed information, allowing for complex “at a glance” planning of one or more rides during the hourly forecast period, and may therefore be desirable to some users at some times. However, presenting all this data at once may also require smaller font sizes, which may restrict the legibility of the output screen, particularly on handheld devices such as mobile phones. Therefore, it may also be desirable to use simpler output screens, such as those depicted in FIGS. 2-4. In one exemplary embodiment, the user may be able to switch at will between two or more of these output modes, in order to maximize the utility of the information at any given time.

FIG. 6 presents exemplary effective temperature and GO/NO-GO information overlaid on the output screen of a trip-planning application. In this particular example, the output screen is from a Google Maps session planning a ride from Denver, Colorado to Salina, Kans., and the information is presented in “callout” boxes (which may be color-coded as indicated by the parenthetical text labels) at the beginning, middle, and endpoint of the planned journey. It may be understood that the system disclosed herein may apply equally well to a variety of different trip planning applications (e.g., MapQuest™, Tom Tom™, VZ Navigator™), and may be used as a data overlay on the output screens of such applications, or may be incorporated directly into the application software itself, or may be embedded into hardware devices such as standalone GPS modules, or GPS modules incorporated into the dashboards of vehicles.

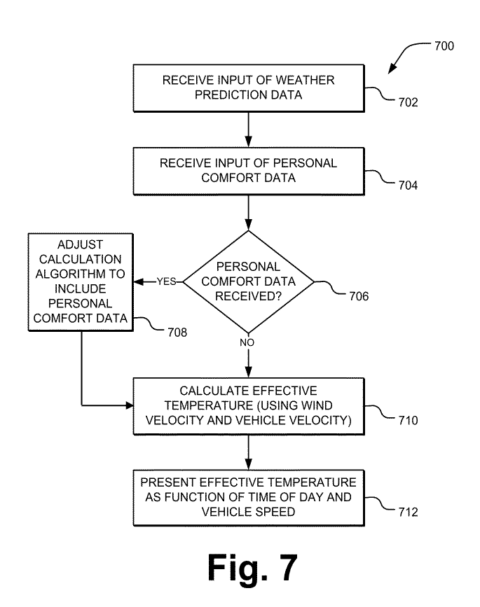

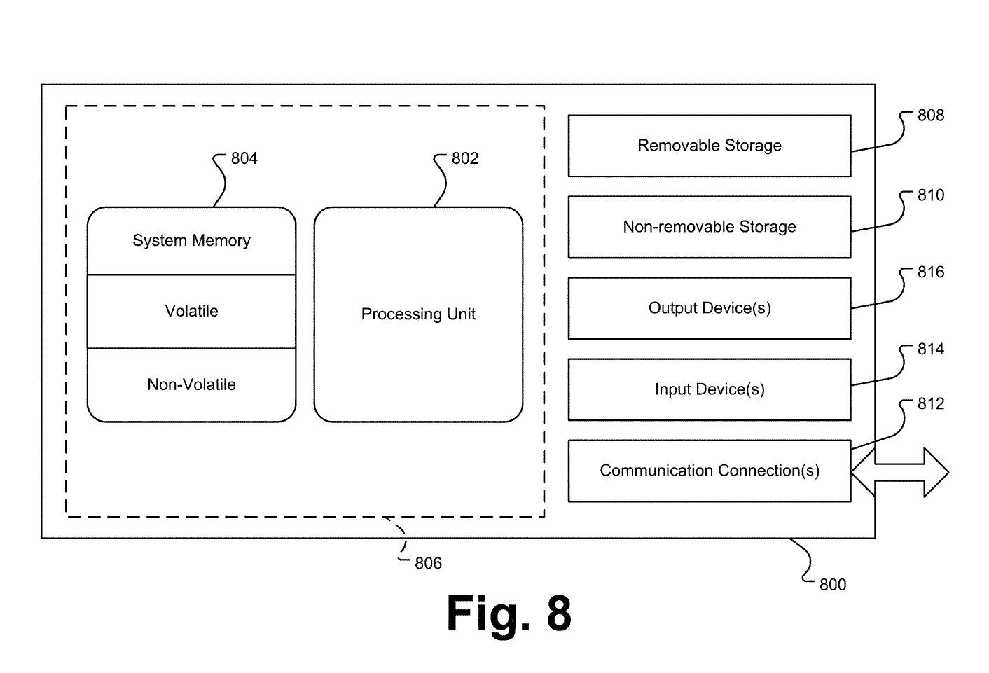

FIG. 7 is a process flow diagram of an exemplary software process 700 for providing effective temperature data, e.g., for providing a GO/NO-GO recommendation for a rider of an exposed rider vehicle, that may be stored in memory in a computer system or on a tangible computer readable medium and performed by the computer system to cause the computer system to function as a special purpose device. In a first operation 702, weather prediction data is received in the computer system. This weather prediction data may be received, for example, from a streaming weather data service and stored in the computer system in either non-volatile or volatile memory. The forecasted weather data may include temperature, barometer, precipitation, cloud cover, daylight, and other weather or environmental predictions for regular time intervals (e.g., hourly increments) over a longer time period (e.g., for a 24 hour or multiple day period). In a second operation 704, the computer system may receive input of user preferences for personal comfort data. These user preferences may be entered into the computer system once and stored in non-volatile memory for use by the process 700 each time a new recommendation request is made by a user. Alternatively, the user preference information may be entered each time a recommendation request is made. Optionally, the process 700 may allow a user to update previously stored preferences at any time desired. In some implementations, the user information may be in the form of a trip map or itinerary of a proposed trip, including probable riding speeds, to be taken by a user.

Since the user preference data is optional, the process 700 next determines whether there is any user preference data regarding personal comfort settings to consider in operation 706. If there is user preference data available, then the standard algorithm for calculating the effective temperature may be modified as indicated in operation 708 and further described above in order to account for the user preference data. Once the desired algorithm is determined, the effective temperature for one or more times or time periods may be calculated as indicated in operation 710. As noted in FIG. 7, a basic calculation of effective temperature will include the parameters of wind velocity and vehicle velocity, but other factors can be included in the calculation as previously described above. Finally, as indicated in operation 712, the effective temperature may be presented to a user as a function of time of day and vehicle speed. As noted above, this presentation may take may different forms. The output may be presented on a display screen or printed or may be audible. The presentation output may be textual, numerical, tabular, or graphical. The presentation output may alternatively be combined within an overall weather report or presented as part of a trip map for a desired route previously input by the user.

FIG. 8 illustrates an exemplary computer system or other processing device 800 configured by the rider comfort prediction method as described herein. The processing device 800 may be in the form of a desktop or laptop computer, a tablet computer, a smartphone or other handheld computing device, a server computer running exemplary processes disclose herein as a web accessible application, a vehicle control or navigation system, or an of myriad other types of computer systems. In one implementation, the processing device 800 typically includes at least one computer processing unit 802 and memory 804. Depending upon the exact configuration and type of the processing device 800, the memory 804 may be volatile (e.g., RAM), non volatile (e.g., ROM and flash memory), or some combination of both. The most basic configuration of the processing device 800 need include only the computer processing unit 802 and the memory 804 as indicated by the dashed line 806.

The processing device 800 may further include additional devices for memory storage or retrieval. These devices may be removable storage devices 808 or non removable storage devices 810, for example, memory cards, magnetic disk drives, magnetic tape drives, and optical drives for memory storage and retrieval on magnetic and optical media. Storage media may include volatile and nonvolatile media, both removable and non removable, and may be provided in any of a number of configurations, for example, RAM, ROM, EEPROM, flash memory, CD-ROM, DVD, or other optical storage medium, magnetic cassettes, magnetic tape, magnetic disk, or other magnetic storage device, or any other memory technology or medium that can be used to store data and can be accessed by the computer processing unit 802. Additional instructions, e.g., in the form of software, that interact with a base operating system to create a special purpose processing device 800, in this implementation, instructions for calculating an effective temperature as described herein and presenting an output of data in a format usable by a rider of an open-air vehicle, may be stored in the memory 804 or on the storage devices 810 using any method or technology for storage of data, for example, computer readable instructions, data structures, and program modules.

The processing device 800 may also have one or more communication interfaces 812 that allow the processing device 800 to communicate with other devices. The communication interface 812 may be connected with a network. The network may be a local area network (LAN), a wide area network (WAN), a telephony network, a cable network, an optical network, the Internet, a direct wired connection, a wireless network, e.g., radio frequency, infrared, microwave, or acoustic, or other networks enabling the transfer of data between devices. Data is generally transmitted to and from the communication interface 812 over the network via a modulated data signal, e.g., a carrier wave or other transport medium. A modulated data signal is an electromagnetic signal with characteristics that can be set or changed in such a manner as to encode data within the signal.

The processing device 800 may further have a variety of input devices 814 and output devices 816. Exemplary input devices 814 may include a keyboard, a mouse, a tablet, a microphone, a scanner, and/or a touch screen device. Exemplary output devices 816 may include a video display, audio speakers, and/or a printer. Such input devices 814 and output devices 816 may be integrated with the processing device 800 or they may be connected to the processing device 800 via wires or wirelessly, e.g., via IEEE 802.11 or Bluetooth protocol. These integrated or peripheral input and output devices are generally well known and are not further discussed herein. Other functions, for example, handling network communication transactions, may be performed by the operating system in the nonvolatile memory 804 of the processing device 800.

It may also be understood that the exact method of presenting the data may vary. For example, the data could provided be in a single pop-up that follows a mouse pointer, such that the user is able to see warnings and effective temperatures evolve both chronologically and spatially by tracing the mouse pointer along the planned route. Alternatively, a display analogous to FIGS. 2-5 may be overlaid on top of first-person visual data such as Google Street View or the equivalent, such that the user may virtually “rehearse” the ride and see comfort data associated with particular visual landmarks. This could be useful, for example, in planning times or locations for wardrobe changes (e.g., donning rain gear, or swapping a leather jacket for an armored mesh jacket), perhaps in conjunction with fueling stops and/or meal stops.

A number of variations are possible on the examples and embodiments described above. For example, the software may accept inputs and give outputs in metric units, or allow a switch between metric and English units based on a specified user preference. The software may be incorporated into a heads-up display, or may audibly announce the weather prediction, effective temperature, and GO/NO-GO recommendation data (e.g., through a Bluetooth headset, phone speaker, or stereo speaker), and may be controlled by voice command, e.g., incorporated into “smart vehicle” systems such as OnStar™ or Ford SYNC™, or “personal assistant” software such as Siri™ or Vlingo™. The outputs of the software may be printed out onto weatherproof reference cards or displayed on weatherproof “electronic paper”. The outputs of the software may be incorporated directly into the weather forecast, for example, on a website such as The Weather Channel's™ weather.com, or as part of a video or audio broadcast, or as part of a weather reporting “widget” or smart phone application, or as part of a daily agenda audibly output. The software or its outputs may be presented in the form of a clock, with recommendations changing hourly, or in the form of a calendar, with course recommendations laid out by day, or in the form of an almanac, with recommendations and predictions printed out in hardcopy for an entire year, based on average weather for particular dates and/or long-term climate patterns. It is noted that the methods for producing weather forecasts and weather almanacs are well established, and require no further elaboration herein. Rather, the methods disclosed herein may be applied to any weather or climate forecast, regardless of how the forecast is generated or reported.

The technology described herein may be implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

All directional references e.g., proximal, distal, upper, lower, inner, outer, upward, downward, left, right, lateral, front, back, top, bottom, above, below, vertical, horizontal, clockwise, and counterclockwise are only used for identification purposes to aid the reader's understanding of the structures disclosed herein, and do not create limitations, particularly as to the position, orientation, or use of such structures. Connection references, e.g., attached, coupled, connected, and joined are to be construed broadly and may include intermediate members between a collection of elements and relative movement between elements unless otherwise indicated. As such, connection references do not necessarily imply that two elements are directly connected and in fixed relation to each other. Stated values shall be interpreted as illustrative only and shall not be taken to be limiting.

The above specification, examples and data provide a complete description of the structure and use of exemplary embodiments of the invention as defined in the claims. Although various embodiments of the claimed invention have been described above with a certain degree of particularity, or with reference to one or more individual embodiments, those skilled in the art could make numerous alterations to the disclosed embodiments without departing from the spirit or scope of the claimed invention. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A method performed by a computer system for predicting and reporting rider comfort for exposed-rider vehicles, comprising
receiving into the computer system input data including weather prediction data;
calculating with a computer processing unit in the computer system an effective temperature based on ambient temperature, wind velocity, and vehicle velocity; and
presenting to an output device or component the effective temperature as a function of time of day and riding speed such that a rider is presented with an enhanced ability to predict comfort and safety of rides at particular times and speeds.

2. The method of claim 1 further comprising
receiving input of user preference data with respect to particular weather conditions; and wherein
the calculating operation further comprises calculating the effective temperature based upon the user preference data.

3. The method of claim 1, wherein the calculating operation further comprises basing the effective temperature calculation on one or both of sunlight or humidity information.

4. The method of claim 1, wherein the presenting operation further comprises presenting the effective temperature data in one or more of the following formats: textually, numerically, in the form of color codes, audibly, or overlaid on top of map data.

5. The method of claim 1 further comprising incorporating the effective temperature data into trip planning software.

6. The method of claim 1 further comprising incorporating the effective temperature data into a separate weather report.

7. A method performed by a computer system for predicting and reporting rider comfort for exposed-rider vehicles, comprising
receiving into the computer system input data including weather prediction data;
optionally receiving input of user preference data with respect to particular weather conditions;
calculating with a computer processing unit in the computer system an effective temperature based on ambient temperature, wind velocity, and vehicle velocity; and
calculating using the computer processing unit in the computer system a GO/NO-GO recommendation for particular travel times based on the calculated effective temperature and user preference data.
presenting to an output device or component the GO/NO-GO recommendation as a function of time of day such that a rider is presented with an enhanced ability to predict comfort and safety of rides at particular times and speeds.

8. The method of claim 7, wherein the calculating operation further comprises basing the effective temperature calculation on one or both of sunlight or humidity information.

9. The method of claim 7, wherein the user preference data includes values for one or more of the following types of data: ambient temperature, ambient wind speed, precipitation, or level of light or darkness.

10. The method of claim 7, wherein the presenting operation further comprises presenting the GO/NO-GO recommendation in one or more of the following formats: textually, numerically, in the form of color codes, audibly, or overlaid on top of map data.

11. The method of claim 7 further comprising incorporating the GO/NO-GO recommendation into trip planning software.

12. The method of claim 7 further comprising incorporating the GO/NO-GO recommendation into a separate weather report.
